(19) United States
(12) Patent Application Publication
(10) Pub. No.: US 2023/0150346 A1
(43) Pub. Date: May 18, 2023

(54) SUPPORTING FRAME AND SUNROOF APPARATUS

(71) Applicant: AISIN CORPORATION, Kariya-shi (JP)

(72) Inventors: Ryuta FUKADA, Suzhou (CN); Xu WANG, Chongqing (CN)

(73) Assignee: AISIN CORPORATION, Kariya-shi (JP)

(21) Appl. No.: 18/054,369

(22) Filed: Nov. 10, 2022

(30) Foreign Application Priority Data
Nov. 17, 2021 (CN) 202122822698.3

(51) Int. Cl. B60J 7/00; B60J 7/043

(52) U.S. Cl. CPC B60J 7/0015; B60J 7/043

(57) ABSTRACT

A supporting frame is configured to support a sunshade of a sunroof apparatus. The supporting frame supports the sunshade from below and includes a first inverted V-shaped protruding portion, a second inverted V-shaped protruding portion, and a third inverted V-shaped protruding portion, which are arranged in order from a downstream side toward an upstream side in an unrolling direction of the sunshade. The third inverted V-shaped protruding portion extends continuously in a longitudinal direction of the supporting frame. The first inverted V-shaped protruding portion and the second inverted V-shaped protruding portion are arranged alternately in the longitudinal direction within a range of the length of the third inverted V-shaped protruding portion such that the sunshade is supported, in the unrolling direction, by the third inverted V-shaped protruding portion and the first inverted V-shaped protruding portion or by the third inverted V-shaped protruding portion and the second inverted V-shaped protruding portion.

### BACKGROUND

### 1. Field

The present disclosure relates to a supporting frame and a sunroof apparatus. Particularly, the present disclosure relates to a supporting frame of a sunroof apparatus for a vehicle.

### 2. Description of Related Art

A structure has been known in which a sunshade is installed in a sunroof apparatus for a vehicle. The sunshade includes a sheet. When it is necessary to provide shade from the sun, the sunshade of the sunroof apparatus is unrolled to cover the light transmitting panel of the sunroof apparatus. When it is not necessary to provide shade from the sun, the sunshade is rolled back to be accommodated at one side of the sunroof apparatus. Specifically, the sunshade is accommodated in a space defined between the vehicle roof and an interior part.

Chinese Utility Model No. 208812953 discloses a sunroof apparatus that includes a supporting frame. When unrolling or rolling back the sunshade, this sunroof apparatus brings two inverted V-shaped protruding portions of the supporting frame into contact with the sunshade, so that the sunshade is smoothly unrolled or rolled back at a specified height while keeping the sheet-shape. Since the sunshade is rolled back to be accommodated in the space defined by the vehicle roof and the interior part, supporting the sunshade with the two inverted V-shaped protruding portions of the supporting frame ensures a clearance between the sunshade and the interior part.

The configuration of the above-described publication includes a guide member that slides on guide rails to guide the sunshade so as to allow the sunshade to be unrolled or rolled back. Depending on the manufacturing tolerances of the guide rails and the supporting frame, the two inverted V-shaped protruding portions may fail to reliably support the sunshade when the vehicle is traveling on a rough road. In such a case, the sunshade may strike the supporting frame and generate unusual striking noise.

### SUMMARY

It is an objective of the present disclosure to provide a supporting frame and a sunroof apparatus that can be manufactured easily at low costs and suppress unusual noise generated by the sunshade striking the supporting frame when the vehicle is traveling on a rough road due to manufacturing tolerances.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a supporting frame is configured to support a sunshade of a sunroof apparatus. The sunshade includes a sheet and is configured to be unrolled from a sunshade holding member and rolled back to the sunshade holding member. The supporting frame supports the sunshade from below. The supporting frame includes a first inverted V-shaped protruding portion, a second inverted V-shaped protruding portion, and a third inverted V-shaped protruding portion, which are arranged in order from a downstream side toward an upstream side in an unrolling direction of the sunshade. The third inverted V-shaped protruding portion extends continuously in a longitudinal direction of the supporting frame. The first inverted V-shaped protruding portion and the second inverted V-shaped protruding portion are arranged alternately in the longitudinal direction within a range of the length of the third inverted V-shaped protruding portion such that the sunshade is supported, in the unrolling direction, by the third inverted V-shaped protruding portion and the first inverted V-shaped protruding portion or by the third inverted V-shaped protruding portion and the second inverted V-shaped protruding portion.

With this configuration, the supporting frame includes the first inverted V-shaped protruding portion and the second inverted V-shaped protruding portion, which extend over the entire length of the third inverted V-shaped protruding portion and are located on the downstream side in the unrolling direction of the third inverted V-shaped protruding portion. The first inverted V-shaped protruding portion and the second inverted V-shaped protruding portion are arranged alternately in the longitudinal direction of the supporting frame. This allows the sunshade to be supported at multiple supporting points in the longitudinal direction, so that the tension of the sunshade is increased. Accordingly, the sunshade is restricted from striking the supporting frame and generating unusual noise.

In the above described configuration, a protruding portion tip of the second inverted V-shaped protruding portion may be at a position higher than a protruding portion tip of the first inverted V-shaped protruding portion and a protruding portion tip of the third inverted V-shaped protruding portion.

Accordingly, the sunshade is firmly supported, so that the tension of the sunshade is increased. Thus, the sunshade is reliably restricted from striking the supporting frame and generating unusual noise.

In the above-described configuration, the first inverted V-shaped protruding portion and the second inverted V-shaped protruding portion may be arranged alternately such that sections of the first inverted V-shaped protruding portion are arranged at opposite ends in the longitudinal direction. Also, the first inverted V-shaped protruding portion may include two or more sections. Further, the first inverted V-shaped protruding portion may include two or three sections.

This allows the sunshade to be supported evenly in the longitudinal direction.

In the above-described configuration, the first inverted V-shaped protruding portion and the second inverted V-shaped protruding portion may be arranged alternately such that sections of the second inverted V-shaped protruding portion are arranged at opposite ends in the longitudinal direction. Also, the second inverted V-shaped protruding portion may include two or more sections. Further, the second inverted V-shaped protruding portion may include two or three sections.

This allows the sunshade to be supported evenly in the longitudinal direction.

The above-described configuration may further include members for attaching the sunshade holding member to opposite ends in the longitudinal direction.

This configuration allows the sunshade holding member to be installed with the supporting frame. This simplifies the structure and reduces the number of components, thereby reducing the manufacturing costs.

In another general aspect, a sunroof apparatus is provided that includes the above-described supporting frame, the sunshade, and the sunshade holding member.

This configuration facilitates the manufacture of the sunroof apparatus and reduces the costs. This configuration also effectively suppresses unusual noise generated by the sunshade striking the supporting frame when the vehicle is traveling on a rough road due to manufacturing tolerances.

Other features and aspects will be apparent from the following detailed description, the drawings, and the claims.

### BRIEF DESCRIPTION OF THE DRAWINGS

FIG. 1 is a partial perspective view schematically showing a sunroof apparatus according to a preferred embodiment.

FIG. 2 is a schematic cross-sectional view as viewed in a direction of arrows A, A in FIG. 1.

FIG. 3 is a plan view of a supporting frame when viewed in direction B in FIG. 2.

FIG. 4 is a schematic cross-sectional view as viewed in a direction of arrows C, C in FIG. 3.

FIG. 5 is a schematic diagram of the supporting frame according to the preferred embodiment.

FIG. 6 is a schematic diagram of a supporting frame according to a first modification.

FIG. 7 is a schematic diagram of a supporting frame according to a second modification.

FIG. 8 is a perspective view showing a part of FIG. 3 as viewed in direction D.

FIG. 9 is a cross-sectional view as viewed in a direction of arrows G, G in FIG. 3, illustrating a case in which a sunshade holding member is installed.

FIG. 10 is a perspective view showing a part of FIG. 3 as viewed in direction E.

FIG. 11 is a cross-sectional view as viewed in a direction of arrows F, F in FIG. 3, illustrating a case in which a sunshade holding member is installed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

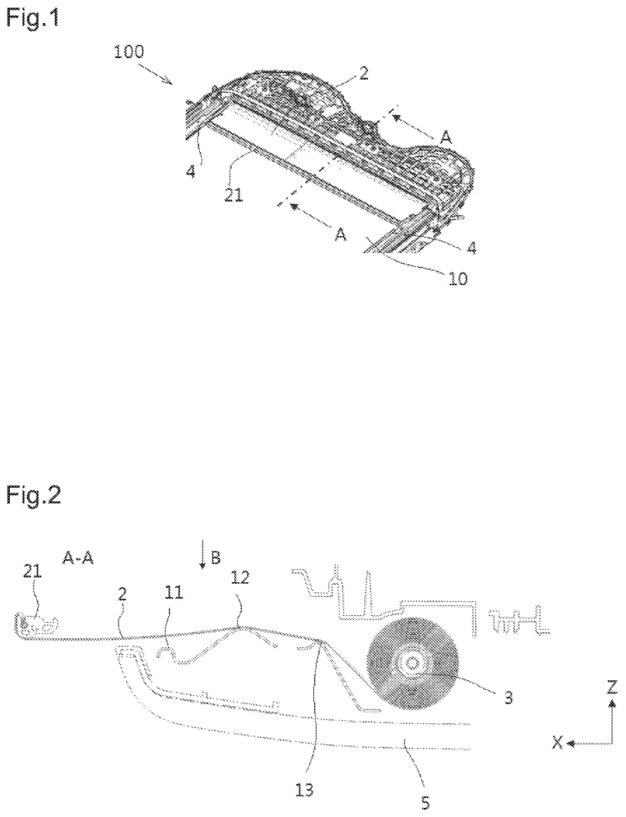

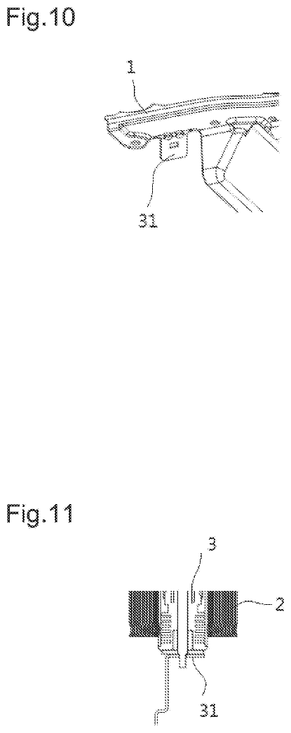

A sunroof apparatus 100 according to a preferred embodiment will now be described with reference to FIGS. 1 to 5 and FIGS. 8 to 11.

The sunroof apparatus 100 includes a supporting frame 1, a sunshade 2, and a sunshade holding member 3.

In the following description, the direction in which the sunshade 2 is unrolled (simply referred to as an unrolling direction in some cases) is defined as a vehicle front-rear direction X, a longitudinal direction of the supporting frame 1 (simply referred to as a longitudinal direction) is defined as a vehicle width direction Y, and a protruding direction of a first inverted V-shaped protruding portion 11, a second inverted V-shaped protruding portion 12, and a third inverted V-shaped protruding portion 13 of the supporting frame 1 is defined as a vehicle up-down direction Z.

The sunshade 2 according to the preferred embodiment is installed in the sunroof apparatus 100 for a vehicle (typical structures of a sunroof apparatus are not shown). The sunshade 2 is used to cover a sunroof opening 10 or light transmitting panel of the sunroof apparatus 100 to provide shade from the sun.

The sunshade 2 includes a sheet made of, for example, a soft light-shielding cloth. As shown in FIG. 2, the sunshade 2 can be unrolled from the sunshade holding member 3 or rolled back into the sunshade holding member 3. Specifically, when it is not necessary to provide shade from the sun, the sunshade 2 is rolled up to be accommodated in the sunshade holding member 3. The sunshade holding member 3 has the shape of a roller with its opposite ends supported by the supporting frame 1 (the structure by which the sunshade holding member 3 is attached to the supporting frame 1 will be discussed below). An edge of the sunshade 2 is fixed to the sunshade holding member 3, and the other edge is fixed to a guide member 21. The guide member 21 is movable along a pair of guide rail members 4 of the sunroof apparatus 100. The guide rail members 4 are provided to be opposed to each other in the vehicle width direction Y. When it is necessary to provide shade from the sun, the guide member 21 is controlled by a motor and a controlling device (neither is shown) so that the guide member 21 moves along the guide rail members 4. Accordingly, the sunshade 2 is drawn out from the sunshade holding member 3 to be unrolled in the unrolling direction. Ultimately, the sunshade 2 is spread to cover the sunroof opening 10 or the light transmitting panel. Thereafter, when it is no longer necessary to provide shade from the sun, the sunshade holding member 3 is rotated in reverse by the motor and the controlling device (neither is shown), so that the unrolled sunshade 2 is rolled back to be accommodated in the sunshade holding member 3.

When the sunshade 2 is unrolled or rolled back, the supporting frame 1 supports the sunshade 2, so that the sunshade 2 is unrolled or rolled back at a specified height. This allows the sunshade 2 to be smoothly unrolled or rolled back without variation in the height in the width direction.

Specifically, the supporting frame 1 is accommodated in a space defined between the vehicle roof and an interior part 5 as shown in FIG. 2. The sunshade 2 is supported by the first inverted V-shaped protruding portion 11, the second inverted V-shaped protruding portion 12, and the third inverted V-shaped protruding portion 13 such that a certain clearance is maintained between the sunshade 2 and the interior part 5.

The supporting frame 1 is a plate including a main body. The main body extends in the vehicle width direction Y, which is orthogonal to the unrolling direction of the sunshade 2. The material for the supporting frame 1 is not particularly limited, and may be any metal such as stainless steel or an aluminum alloy. Alternatively, the material may be a plastic.

The supporting frame 1 supports the sunshade 2 from below and includes the first inverted V-shaped protruding portion 11, the second inverted V-shaped protruding portion 12, and the third inverted V-shaped protruding portion 13, which are arranged in order from the downstream side toward the upstream side in the unrolling direction of the sunshade 2. The upstream-most side in the unrolling direction of the sunshade 2 is closest to the sunshade holding member 3, and the downstream-most side in the unrolling direction of the sunshade 2 is a position at which the guide member 21 is located when the sunshade 2 is fully unrolled.

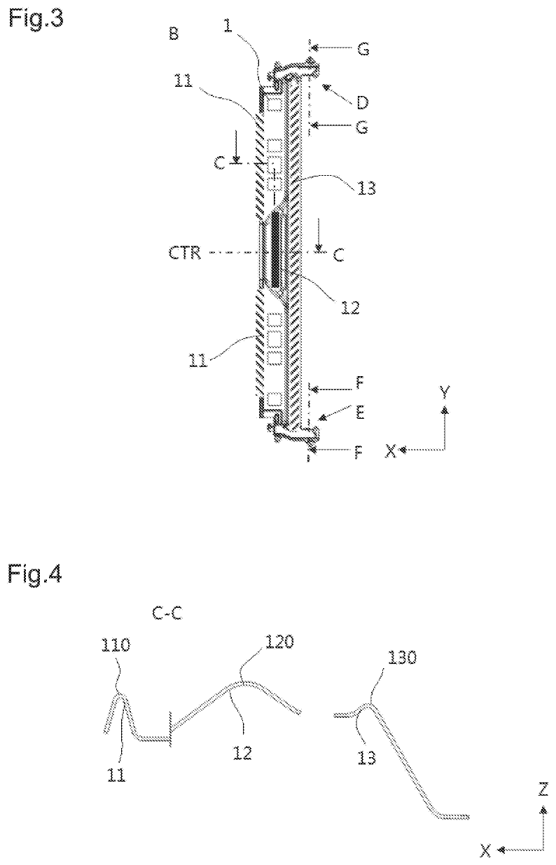

The third inverted V-shaped protruding portion 13 extends continuously in the longitudinal direction of the supporting frame 1. Specifically, with reference to FIGS. 3 to 5, the third inverted V-shaped protruding portion 13 protrudes upward, and extends linearly and continuously in the longitudinal direction. More specifically, the third inverted V-shaped protruding portion 13 includes a protruding portion tip 130, which extends linearly and continuously in the longitudinal direction. However, the third inverted V-shaped protruding portion 13 does not necessarily need to extend linearly, but may extend to form a curve. It suffices if the third inverted V-shaped protruding portion 13 extends continuously in the longitudinal direction so as to support the sunshade 2. The protruding height of the third inverted V-shaped protruding portion 13 is substantially constant in the longitudinal direction, but may vary slightly in correspondence with, for example, the material of the sunshade 2.

The first inverted V-shaped protruding portion 11 and the second inverted V-shaped protruding portion 12 are arranged alternately in the longitudinal direction within the range of the length of the third inverted V-shaped protruding portion 13 such that the sunshade 2 is supported, in the unrolling direction, by the third inverted V-shaped protruding portion 13 and the first inverted V-shaped protruding portion 11 or by the third inverted V-shaped protruding portion 13 and the second inverted V-shaped protruding portion 12.

That is, the first inverted V-shaped protruding portion 11 and the second inverted V-shaped protruding portion 12 are arranged alternately within the range of the length of the third inverted V-shaped protruding portion 13 such that the first inverted V-shaped protruding portion 11 and the second inverted V-shaped protruding portion 12 are successive in the longitudinal direction.

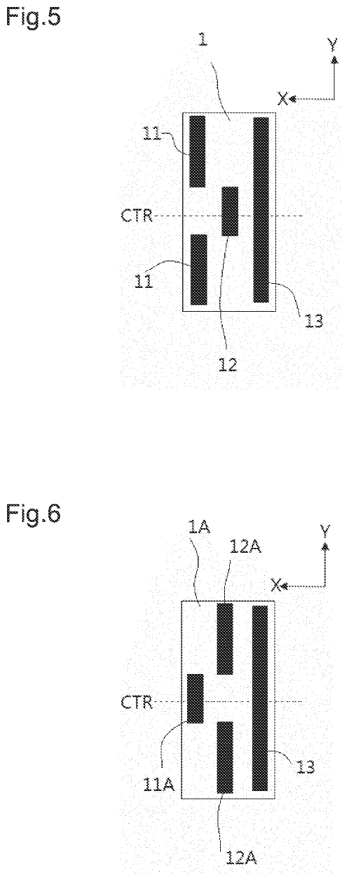

In the present embodiment, sections of the first inverted V-shaped protruding portion 11 and the second inverted V-shaped protruding portion 12 are arranged alternately such that the sections of the first inverted V-shaped protruding portion 11 are arranged at the opposite ends in the longitudinal direction. More specifically, two sections of the first inverted V-shaped protruding portion 11 are formed in correspondence with the opposite ends of the continuously extending third inverted V-shaped protruding portion 13 as shown in FIG. 5. The second inverted V-shaped protruding portion 12 is arranged between the two sections of the first inverted V-shaped protruding portion 11, so as to face the third inverted V-shaped protruding portion 13. A central axis CTR, which extends in the unrolling direction of the supporting frame 1, extends through the second inverted V-shaped protruding portion 12 and the third inverted V-shaped protruding portion 13. The first inverted V-shaped protruding portion 11 preferably includes two or more sections.

That is, if the supporting frame 1 is cut along a plane defined by the vehicle front-rear direction X and the vehicle up-down direction Z, and that plane is moved in the vehicle width direction Y, a cross-section view including the first inverted V-shaped protruding portion 11 and the third inverted V-shaped protruding portion 13, a cross-section view including the second inverted V-shaped protruding portion 12 and the third inverted V-shaped protruding portion 13, and a cross-section view including the first inverted V-shaped protruding portion 11 and the third inverted V-shaped protruding portion 13 are obtained successively.

Any cross-sectional view within a range of the length in which the third inverted V-shaped protruding portion 13 extends continuously includes two protruding portion tips (a protruding portion tip 120 and a protruding portion tip 130, or a protruding portion tip 110 and the protruding portion tip 130). The sections of the first inverted V-shaped protruding portion 11 and the second inverted V-shaped protruding portion 12 are arranged alternately such that the distance between two protruding portion tips varies in the order of a long distance, a short distance, and a long distance within the continuous range of the length.

The first inverted V-shaped protruding portion 11 and the second inverted V-shaped protruding portion 12 protrude upward and extend linearly in the longitudinal direction like the third inverted V-shaped protruding portion 13. More specifically, the protruding portion tip 110 of the first inverted V-shaped protruding portion 11 and the protruding portion tip 120 of the second inverted V-shaped protruding portion 12 extend linearly in the longitudinal direction. However, the first inverted V-shaped protruding portion 11 and the second inverted V-shaped protruding portion 12 do not necessarily need to extend linearly, but may extend to form curves. It suffices if the first inverted V-shaped protruding portion 11 and the second inverted V-shaped protruding portion 12 support the sunshade 2 effectively. The protruding height of the first inverted V-shaped protruding portion 11 is substantially constant in the longitudinal direction, but may vary slightly in correspondence with, for example, the material of the sunshade 2. The protruding height of the second inverted V-shaped protruding portion 12 is substantially constant in the longitudinal direction, but may vary slightly in correspondence with, for example, the material of the sunshade 2.

In the present embodiment, the protruding portion tip 120 of the second inverted V-shaped protruding portion 12 is located above the protruding portion tip 110 of the first inverted V-shaped protruding portion 11 and the protruding portion tip 130 of the third inverted V-shaped protruding portion 13. That is, the second inverted V-shaped protruding portion 12 is higher than the first inverted V-shaped protruding portion 11 and the third inverted V-shaped protruding portion 13.

In the supporting frame 1 of the present embodiment, a section of the first inverted V-shaped protruding portion 11, the second inverted V-shaped protruding portion 12, and the other section of the first inverted V-shaped protruding portion 11 are arranged alternately in the longitudinal direction of the supporting frame 1. The supporting frame 1 of the present embodiment includes the third inverted V-shaped protruding portion 13, which is located on the upstream side and extends continuously in the longitudinal direction. This allows the sunshade 2 to be supported at multiple supporting points in the longitudinal direction, so that the tension of the sunshade 2 is increased. Accordingly, the sunshade 2 is restricted from striking the supporting frame 1 and generating unusual noise.

The structure for attaching the sunshade holding member 3 to the supporting frame 1 will now be described with reference to FIGS. 8 to 11.

The supporting frame 1 includes members for attaching the sunshade holding member 3 to the opposite ends in the longitudinal direction. Specifically, the supporting frame 1 includes a fixed attachment portion 31 and a movable attachment portion 32 at the opposite ends in the longitudinal direction. The fixed attachment portion 31 and the movable attachment portion 32 protrude downward. The sunshade holding member 3 includes a rectangular insertion portion at a first end of its spool. The insertion portion is inserted into a rectangular hole formed in the fixed attachment portion 31. A sleeve is rotatably fitted about a second end of the spool of the sunshade holding member 3. A circular end of the sleeve is inserted into a circular hole formed in the movable attachment portion 32. The sunshade 2 is wound about the sleeve. The first end of the sunshade holding member 3 is fixed to the fixed attachment portion 31 with the insertion portion, and the second end of the sunshade holding member 3 includes a spring member fixed to the sleeve. The spring member is twisted when the sunshade 2 is unrolled. When the sunshade 2 is rolled back, the elastic restoring force of the spring member allows the sunshade 2 to be rolled back smoothly. This allows the sunshade holding member 3 to be supported simultaneously by the supporting frame 1.

<First Modification>

In the above-described preferred embodiment, the supporting frame 1 is described. In the following, a supporting frame 1A according to a first modification will be described with reference to FIG. 6. The third inverted V-shaped protruding portion 13 in the first modification is the same as that in the preferred embodiment. Thus, the same reference numeral is given and the detailed explanation is omitted.

The supporting frame 1A includes a first inverted V-shaped protruding portion 11A and a second inverted V-shaped protruding portion 12A, which are arranged alternately such that sections of the second inverted V-shaped protruding portion 12A are arranged at the opposite ends in a longitudinal direction Y.

That is, two sections of the second inverted V-shaped protruding portion 12A are formed in correspondence with the opposite ends of the continuously extending third inverted V-shaped protruding portion 13. The first inverted V-shaped protruding portion 11A is arranged between the two sections of the second inverted V-shaped protruding portion 12A, so as to face the third inverted V-shaped protruding portion 13. The central axis CTR, which extends in the unrolling direction of the supporting frame 1A, extends through the first inverted V-shaped protruding portion 11A and the third inverted V-shaped protruding portion 13.

The first modification is different from the preferred embodiment in that the arrangements of the first inverted V-shaped protruding portion and the second inverted V-shaped protruding portion are reversed.

The other configuration of the first modification is the same as that of the preferred embodiment, and achieves advantages similar to those of the preferred embodiment.

<Second Modification>

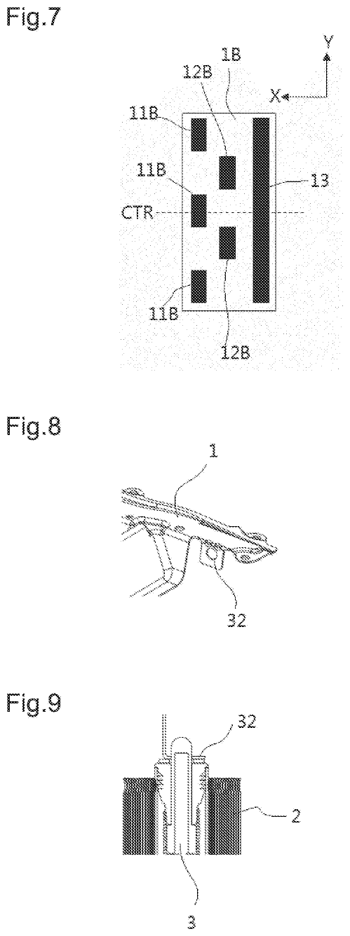

In the above-described preferred embodiment, the supporting frame 1 is described. In the following, a supporting frame 1B according to a second modification will be described with reference to FIG. 7. The third inverted V-shaped protruding portion 13 in the second modification is the same as that in the preferred embodiment. Thus, the same reference numeral is given and the detailed explanation is omitted.

The supporting frame 1B includes a first inverted V-shaped protruding portion 11B and a second inverted V-shaped protruding portion 12B, which are arranged alternately such that sections of the first inverted V-shaped protruding portion 11B are arranged at the opposite ends in a longitudinal direction Y. The second modification is different from the preferred embodiment in that the first inverted V-shaped protruding portion 11B includes three sections. That is, one section of the first inverted V-shaped protruding portion 11B, one section of the second inverted V-shaped protruding portion 12B, another section of the first inverted V-shaped protruding portion 11B, the other section of the second inverted V-shaped protruding portion 12B, and the other section of the first inverted V-shaped protruding portion 11B are arranged alternately in the longitudinal direction from the first end. The central axis CTR, which extends in the unrolling direction of the supporting frame 1B, extends through the middle section of the first inverted V-shaped protruding portion 11B and the third inverted V-shaped protruding portion 13.

The other configuration of the second modification is the same as that of the preferred embodiment, and achieves advantages similar to those of the preferred embodiment.

As in the second modification, the second inverted V-shaped protruding portion may include three sections, and the second inverted V-shaped protruding portion may include two or more sections in the first modification.

In addition to the preferred embodiment and its modifications, which have been described, the present disclosure may be modified further.

For example, in the above-described embodiment and its modifications, the numbers of sections of the first inverted V-shaped protruding portion and the second inverted V-shaped protruding portion are limited. However, the present disclosure is not limited to these. The numbers of sections of the first inverted V-shaped protruding portion and the second inverted V-shaped protruding portion may be set freely as long as the sections of the first inverted V-shaped protruding portion and the second inverted V-shaped protruding portion are arranged alternately. For example, only one section of the first inverted V-shaped protruding portion and only one section of second inverted V-shaped protruding portion may be provided.

For example, in the above-described embodiment and its modifications, the protruding portion tip of the second inverted V-shaped protruding portion is at a position higher than the protruding portion tip of the first inverted V-shaped protruding portion and the protruding portion tip of the third inverted V-shaped protruding portion. However, the present disclosure is not limited to this. For example, the height of each inverted V-shaped protruding portion may be changed in accordance with the practical necessity.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A supporting frame configured to support a sunshade of a sunroof apparatus, wherein
the sunshade includes a sheet and is configured to be unrolled from a sunshade holding member and rolled back to the sunshade holding member,
the supporting frame supports the sunshade from below,
the supporting frame includes a first inverted V-shaped protruding portion, a second inverted V-shaped protruding portion, and a third inverted V-shaped protruding portion, which are arranged in order from a downstream side toward an upstream side in an unrolling direction of the sunshade,
the third inverted V-shaped protruding portion extends continuously in a longitudinal direction of the supporting frame,
the first inverted V-shaped protruding portion and the second inverted V-shaped protruding portion are arranged alternately in the longitudinal direction within a range of the length of the third inverted V-shaped protruding portion such that the sunshade is supported, in the unrolling direction, by the third inverted V-shaped protruding portion and the first inverted V-shaped protruding portion or by the third inverted V-shaped protruding portion and the second inverted V-shaped protruding portion.

2. The supporting frame according to claim 1, wherein a protruding portion tip of the second inverted V-shaped protruding portion is at a position higher than a protruding portion tip of the first inverted V-shaped protruding portion and a protruding portion tip of the third inverted V-shaped protruding portion.

3. The supporting frame according to claim 1, wherein the first inverted V-shaped protruding portion and the second inverted V-shaped protruding portion are arranged alternately such that sections of the first inverted V-shaped protruding portion are arranged at opposite ends in the longitudinal direction.

4. The supporting frame according to claim 1, wherein the first inverted V-shaped protruding portion and the second inverted V-shaped protruding portion are arranged alternately such that sections of the second inverted V-shaped protruding portion are arranged at opposite ends in the longitudinal direction.

5. The supporting frame according to claim 3, wherein the first inverted V-shaped protruding portion includes two or more sections.

6. The supporting frame according to claim 4, wherein the second inverted V-shaped protruding portion includes two or more sections.

7. The supporting frame according to claim 5, wherein the first inverted V-shaped protruding portion includes two or three sections.

8. The supporting frame according to claim 6, wherein the second inverted V-shaped protruding portion includes two or three sections.

9. The supporting frame according to claim 1, comprising members for attaching the sunshade holding member to opposite ends in the longitudinal direction.

10. A sunroof apparatus, comprising:
the supporting frame according to claim 1;
the sunshade; and
the sunshade holding member.
